(19) United States
(12) Patent Application Publication
(10) Pub. No.: US 2008/0070091 A1
(43) Pub. Date: Mar. 20, 2008

(54) SEAL RETENTION FEATURE FOR FUEL CELL ASSEMBLY

(76) Inventor: Jack A.C. Kummerow, Paris, TN (US)

Correspondence Address: MARSHALL & MELHORN, LLC, FOUR SEAGATE, 8TH FLOOR, TOLEDO, OH, 43804, US

(21) Appl. No.: 11/531,944

(22) Filed: Sep. 14, 2006

(51) Int. Cl. H01M 2/08; H01M 8/02; F16J 15/06

(52) U.S. Cl. 429/35; 429/38; 277/650

(57) ABSTRACT

Seal retention mechanism for a fuel cell assembly having two plates is disclosed. The seal retention mechanism includes first and second fuel cell plates. The first fuel cell plate has a seal groove that includes at least one aperture formed through a base of the groove. The second fuel cell plate is positioned adjacent to the first fuel cell. The second fuel cell has a cavity in general alignment with the aperture of the first fuel cell plate. The seal groove, aperture and cavity are filled with seal material whereby a portion of the seal material forms a bridge between the first and second fuel cell plates. The seal material at least partially fills the cavity such that the seal groove, aperture, and cavity cooperate to retain the seal material within the seal groove after curing.

### FIELD

The subject matter in the present application assembly relates to fuel cells, and more particularly to methods and materials for enhancing retention characteristics of seals to a fuel cell assembly.

### BACKGROUND

It is known to apply resilient sealing beads to and between the faces of fuel cell plates for controlling fluid flow between a series of such plates, stacked in pairs and bonded together for generating electric power. In a typical fuel cell stack arrangement, the plates are sandwiched together in a parallel, face-to-face pattern. The plates are held spaced apart by resilient sealing beads that fit within grooves on the faces of the plates, and define paths or channels for fluids to flow between the plates. In some cases, the sealing beads are adhesively bonded to the face of at least one of any two adjoining plates. In other cases, the sealing beads are simply held in place by compressive pressure created by bolted connections between plates.

Each fuel cell assembly is comprised of a cathode and an anode plate. A coolant material, such as, for example, glycol-based anti-freeze or deionized water, flows between each cathode and anode plate of each cell. Two chemically reactive elements, i.e., hydrogen and oxygen, flow between each fuel cell assembly wherein each assembly is separated by a catalytic membrane. The hydrogen and oxygen elements react at the membrane to form water vapor in a type of reverse electrolysis.

The nature of the chemical reaction, along with a need for separation of the coolant from the reacting elements, occasionally requires that extreme or costly measures be taken to avoid leakage through or between the plates. Despite such expenditures, fluid leaks are known to occur as a result of insufficient bonding of the sealing beads to the plates can sometimes lead to the beads becoming completely detached from the plate surface. Thus, an improved mechanism is needed to retain sealing beads to fuel cell plates, one that is highly reliable, particularly in mass production manufacturing environments.

### SUMMARY

A seal retention mechanism is disclosed for retaining seal material within grooves formed in fuel cell plate assemblies. The seal retention mechanism includes first and second fuel cell plates. The first fuel cell plate has a seal groove that includes at least one aperture formed through a base of the groove. The second fuel cell plate is positioned adjacent to the first fuel cell. The second fuel cell has a cavity in general alignment with the aperture of the first fuel cell plate. The seal groove, aperture and cavity are filled with seal material whereby a portion of the seal material forms a bridge between the first and second fuel cell plates. The seal material at least partially fills the cavity such that the seal groove, aperture, and cavity cooperate to retain the seal material within the seal groove after curing.

### BRIEF DESCRIPTION OF THE DRAWINGS

FIG. 1 illustrates an exploded cross-sectional view of an embodiment of fuel cell plates with a seal retention mechanism.

FIGS. 2A and 2B illustrate front and rear views of an embodiment of a fuel cell plate with the seal retention mechanism.

FIG. 3 illustrates a cross-sectional view of an embodiment of assembled fuel cell plates with the seal retention mechanism.

### DETAILED DESCRIPTION OF THE PREFERRED EMBODIMENTS

Embodiments of fuel cell plates described herein include a seal retention mechanism configured to improve the retention of sealing bead material to fuel cell plates. The seal retention mechanism does not rely on through-holes wherein holes are formed in plates to integrally connect two sealing beads, one on each side of a fuel cell assembly. The seal retention mechanism described herein does not pass through the plates, thereby eliminating a potential leak path within the fuel cell assembly.

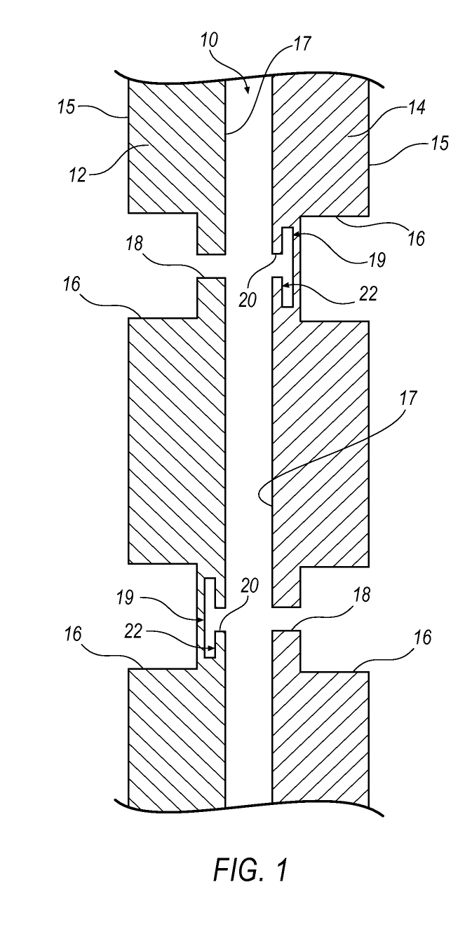

FIG. 1 illustrates an exploded cross sectional view of a fuel cell assembly 10 including a first fuel cell plate 12 and a second fuel cell plate 14. The polarity of the plates 12, 14, i.e., anode and cathode, are not critical to the effectiveness of the seal retention features described herein.

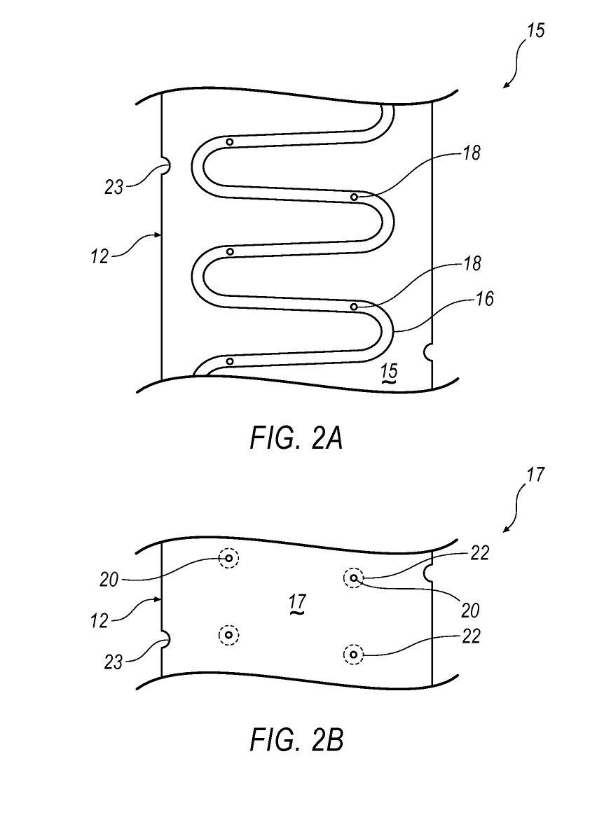

As illustrated, each plate 12, 14 includes grooves 16 formed on a front face 15 (See FIG. 2A) thereof. Preferably, the grooves 16 have the approximately same centerline wherein the grooves 16 on each plate 12, 14, mirrors the other. The configuration of the grooves 16 herein are merely exemplary and are not intended to be limiting as various shapes and configurations are foreseeable. The grooves 16 are configured to receive sealing bead material that defines paths or channels in which fluid can flow between the plates 12, 14. Each groove 16 includes one or more apertures 18 formed along its length.

As best illustrated in FIGS. 1 and 2B, each plate 12, 14, includes one or more cavities 19 formed on a rear face 17 thereof. Preferably, each cavity 19 is formed with an opening 20 and a base 22 wherein the base 22 is larger in area than the opening 20 such that the retention characteristic of the mechanism is enhanced. To construct the seal retention mechanism, the apertures 18 of the first fuel cell plate 12 are configured to generally align with the openings 20 of the cavities 19 formed in the second fuel cell plate 14 and vice versa. Each fuel cell plate 12, 14 may include an alignment marking 23 (see e.g., FIGS. 2A, 2B) to assist in ensuring the proper alignment of the apertures 18 and openings 19. The cavities 19 may be formed in various shapes and sizes but does not form a through-hole in the fuel cell plate.

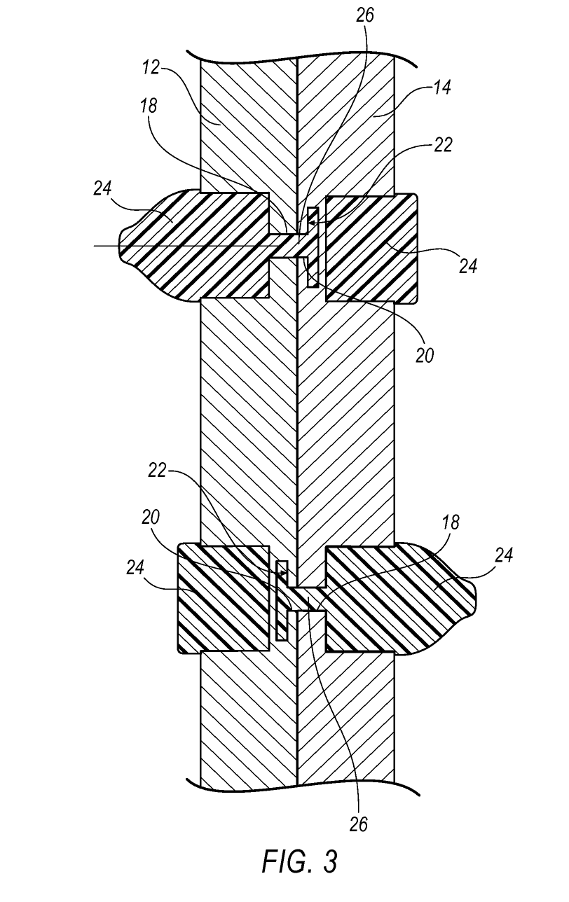

FIG. 3 illustrates an embodiment of an assembled fuel cell plates having the seal retention mechanism. After aligning the apertures 18 and openings 20 of the fuel cell plates 12, 14, a sealing material 24 is deposited within the grooves 16 through one of many molding processes known to those skilled in the art. The sealing material 24, preferably formed of an elastomeric material, is employed to seal the plates together and prevent fluid leaks within and between assemblies. The sealing material 24 is preferably applied in the form of a curable fluid sealing material, which after being cured in place, is adapted to facilitate control of fluid flows, such as coolants between the plates, and of electrolyte flows between fuel cells.

During the molding process, the sealing material 24 flows within the grooves 16, through the apertures 18 and into the cavities 19. After curing, the sealing material 24 within the cavities 19 operate to mechanically retain or anchor the sealing material 24 within the grooves 16, with the material extending between corresponding aperture 18 and opening 20 serving as a bridge 26 between each plate 12, 14.

It is to be understood that the above description is intended to be illustrative and not limiting. Many embodiments will be apparent to those of skill in the art upon reading the above description. Therefore, the scope of the invention should be determined, not with reference to the above description, but instead with reference to the appended claims, along with the full scope of equivalents to which such claims are entitled.

What is claimed is:

1. A seal retention mechanism for retaining seal material to fuel cell plate assemblies, said retention mechanism comprising:
a first fuel cell plate having a seal groove that includes at least one aperture formed through a base thereof;
a second fuel cell plate positioned adjacent to said first fuel cell plate, said second fuel cell plate having a cavity in general alignment with said aperture of said first fuel cell plate; and
wherein said seal groove, aperture and cavity are filled with seal material whereby a portion of said seal material forms a bridge between the first and second fuel cell plates and at least partially fills said cavity such that the seal groove, aperture and cavity cooperate to retain said seal material within said seal groove after curing.

2. The mechanism of claim 1 wherein said seal is formed of an elastomeric material.

3. The mechanism of claim 1 wherein said plates each include at least one alignment indicator.

4. The mechanism of claim 1 wherein said grooves on each plate mirror each other.

5. The mechanism of claim 1 wherein said cavity is includes an opening and a base.

6. The mechanism of claim 5 wherein the area of said base is larger than the area of said opening.

7. A seal retention mechanism for retaining seal material to fuel cell plate assemblies, said retention mechanism comprising:
a first fuel cell plate having a seal groove formed in a first face of said first fuel cell plate, wherein said seal groove includes at least one aperture that is substantially smaller than size of the groove formed in the first face of the first bipolar plate, wherein said aperture extends from a base portion of said groove and through said first fuel cell place to a second face of said first fuel cell plate;
a second fuel cell plate positioned adjacent to said first fuel cell plate, said second fuel cell plate having a cavity formed therein, said cavity further including opening extending therefrom to a first face of said second fuel cell plate, wherein said opening is in generally alignment with said aperture of said first fuel cell plate; and
wherein said seal groove, aperture, opening and cavity are filled with seal material whereby a portion of said seal material filling said aperture and opening forms a bridge between the first and second fuel cell plates, wherein said seal material substantially fills said cavity, such that said seal groove, aperture, opening and cavity cooperate to retain said seal material within said seal groove after curing.
